(19) United States
(12) Patent Application Publication
(10) Pub. No.: US 2008/0192995 A1
(43) Pub. Date: Aug. 14, 2008

(54) Example-Based Diagnosis Decision Support

(75) Inventor: Luyin Zhao, White Plains, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronic, N.V., Eindhoven (NL)

(21) Appl. No.: 10/597,039

(22) PCT Filed: Jan. 21, 2005
(86) PCT No.: PCT/IB2005/050252

§ 371 Date: Jul. 7, 2006

Related U.S. Application Data
(60) Provisional application No. 60/539,303, filed on Jan. 26, 2004.

(51) Int. Cl. G06K 9/00

(52) U.S. Cl. 382/128

(57) ABSTRACT

A computer-aided diagnosis (CAD) technique matches an image of an undiagnosed tumor against respective images of a group of tumors of known pathology, either malignant or benign (104, 208). Either a database of malignant tumor images is designated, or a database of benign tumors is designated (112). The closest group of reference tumor images in terms of similarity is found (228). Similarity between the test image and the group of reference images is determined by the smallest Mahalanobis distance between the test and reference images (216). The group is altered by a genetic algorithm to include different images that are then tested for distance, this process being iteratively executed subject to a stopping criterion (216, 220, 224, 228).

The present invention relates to automated diagnosis support, and, more particularly, to support that provides examples of similar known cases.

Healthcare diagnosis decision support systems or computer-aided diagnosis (CAD) systems are used to classify unknown tumors detected on digital images into different categories, e.g., malignant or benign. Usually, machine-learning technologies, such as decision tree and neural network, are utilized to build classifiers based on a large number of known cases with ground truth, i.e., cases for which the diagnosis has been confirmed by pathology. Once the classifier is created for accepting a set of features as inputs, the diagnosis is performed by extracting from the unknown tumor case such features for input into the classifier. The classifier output indicates the estimated nature (e.g. malignant/benign) of the unknown tumor and optionally a confidence value. As the precision of medical imaging facilities improves, this type of computer-aided diagnosis becomes more and more important as a tool for the physician.

U.S. Patent Publication 2001/0043729 A1 to Giger et al. (hereinafter “Giger”), entitled “Method, System and Computer Readable Medium for an Intelligent Search Workstation for Computer Assisted Interpretation of Medical Images,” the entire disclosure of which is hereby incorporated herein by reference, discloses use of a classifier to automatically determine a diagnosis that includes a likelihood of pathology, the device also retrieving from the database and displaying on-screen known cases or examples that have been determined to be similar to the case being diagnosed. The fetched cases are color-coded in the display to indicate whether the tumor is malignant or benign.

Similarity between the test case and a known case is assessed based on the Euclidean distance between the two cases. In particular, features deemed to be relevant to the existence/non-existence of pathology such as margin, shape, density and spiculation discernible in the image of the tumor are each assigned a dimension in n-dimensional space. The difference in value between the test and known case for each feature determines an n-dimensional scalar whose length is the Euclidean distance between the test and known cases. A predetermined number of cases, malignant or benign, having smallest Euclidean distance are selected to fill the display for viewing by the radiologist or doctor.

In assessing similarity on a one-to-one basis, however, the Giger patent publication does not account for interaction among features, and therefore delivers a less than optimum group of cases for display.

Also, displaying both malignant and benign cases interspersed side-by-side as in Giger can be confusing and limits the amount of screen area for displaying a desired number of similar cases of the same type, i.e., either malignant or benign.

The present invention has been made to address the above-noted shortcomings in the prior art. It is an object of the invention to select for display, as a complement to an automated diagnosis of a tumor as malignant or benign, images of known cases whose similarity is assessed by a one-to-many metric that provides greater similarity than can be achieved using the Euclidean distance.

In brief, a test medical, multi-featured image of a tumor is compared either to a collection of reference medical, multi-featured images of tumors determined to be malignant, or to an analogous collection of non-malignant tumor images, to identify reference images that are similar feature-wise to the test image. Reference images are selected from the designated collection to form respective groups of the selected images. A genetic algorithm is applied to alter groups, and to determine which of the groups is at a minimum distance to the test image based on the feature values of the test image and those of reference images of the group.

Details of the invention disclosed herein shall be described with the aid of the figures listed below, wherein:

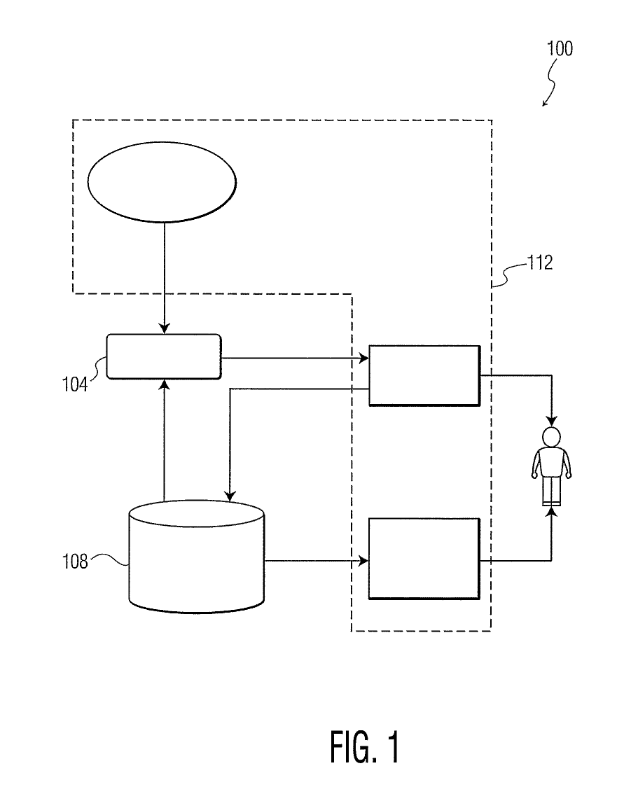

FIG. 1 is a flow diagram depicting an overview of a system in accordance with the present invention;

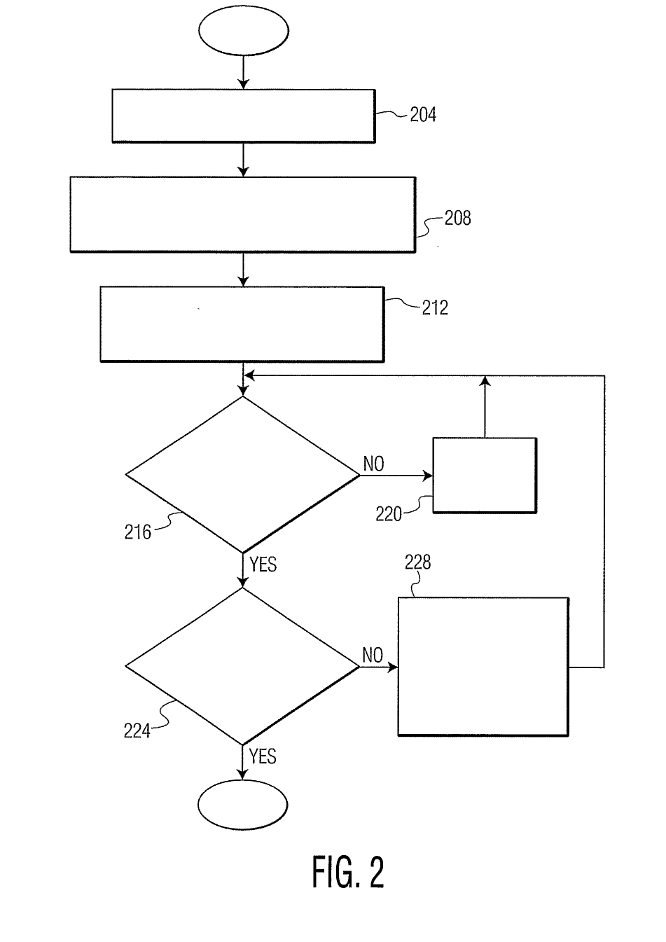

FIG. 2 is a flow chart illustrating an example of a process in accordance with the present invention;

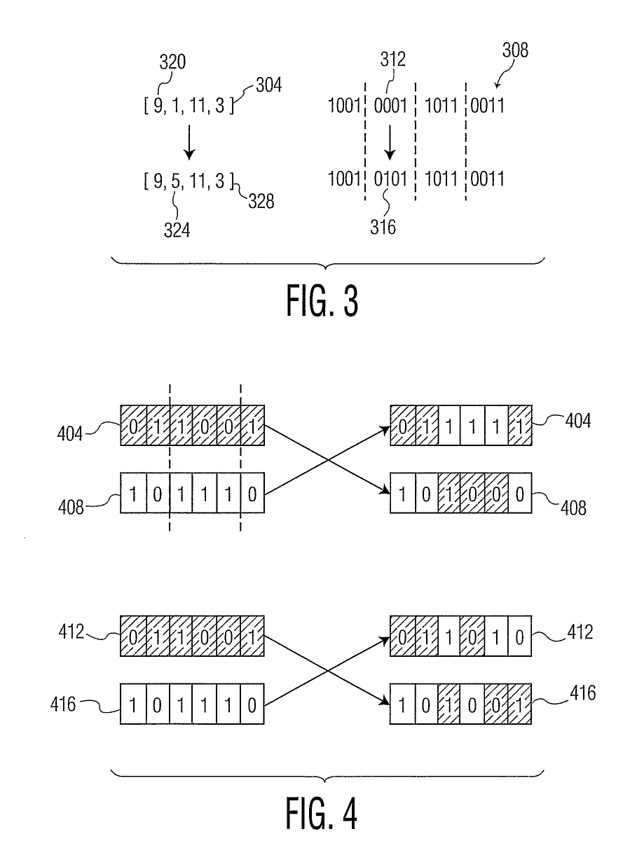

FIG. 3 is a conceptual diagram of an image searching process in accordance with the present invention; and

FIG. 4 is a conceptual diagram of another image searching process in accordance with the present invention.

FIG. 1 depicts processing flow in an exemplary sample-based diagnosis decision support system 100 in accordance with the present invention. The system 100 may be implemented as the general-purpose computer shown in FIG. 9 of Giger (US Patent Publication 2001/0043729 A1) running software in accordance with the present invention, or, alternatively, as a corresponding dedicated processor similarly incorporating the present invention.

As shown in FIG. 1, the system 100 includes a classifier 104, a database of known cases 108 and an input/output module 112 that includes application logic and elements such as a display screen and keyboard (not shown). The classifier 104 is trained on a large number of known tumor cases from the database 108 or other database. The learning process can be conducted by any one of many existing machine learning approaches such as those employing a decision tree, artificial neural network or spiking neural network.

To analyze a new tumor, features are extracted by the input/output module 112 and fed to the classifier 104. The classification result can be either malignant, benign or a determined likelihood of malignancy.

Upon receiving this result, the input/output module 112 sends to the database 108 a request that includes the values for each extracted feature of the new tumor, the nature of the tumor, i.e. malignant or benign, and the number of instances wanted. If the classification result is a likelihood larger than 50%, the nature of the tumor is malignant; otherwise, it is benign. The database 108 is divided into two collections, one having only malignant cases and the other having only benign cases. If the nature of the new tumor is malignant, the collection having malignant cases is searched for similar cases; otherwise, the other collection is searched.

Once the similar cases are retrieved, the input/output module 112, displays to the user the classification result, and image of the new tumor, and images of the most similar cases.

FIG. 2 illustrates, by way of non-limitative example, a process in accordance with the present invention. Before using the system 100 to find cases similar to the new tumor, the database 108 is prepared by dividing it in accordance with pathology into a malignant collection and a benign collection. This is preferably accomplished by consecutively numbering the cases in each collection separately. Accordingly, if there are 1000 malignant cases for example, they may be numbered from O to 999 (step 204).

In processing the new tumor, similar cases are retrieved from the collection that was designated, i.e., from the collection named by the classification result determined by the classifier 104 based on the new tumor.

Confining retrieval to one kind of case increases the number of cases that can be simultaneously displayed to the doctor. The increased number of cases and their single type, i.e., malignant or benign, enhances the effectiveness of a one-to-many distance metric as used to advantage in the present invention. The difficulty of finding groups of cases suitable for the one-to-many distance metric is overcome by use of a genetic algorithm as discussed in more detail below.

The retrieval, in accordance with the inventive method, first involves an initial selection of a predetermined number of cases from the designated collection. This selection may be at random, since the genetic algorithm of the present invention will, through iterative changes in the selection, deliver a final optimal group of cases no matter which cases are initially selected. A random number generator may be included in the system 100 for this purpose. Nevertheless, for faster results, the initial group of cases may be selected based on a relatively rough measure of similarity. A one-to-one metric such as Euclidean distance, for example, may be employed.

The initially selected cases are allocated into groups or “genes.” Therefore, for example, n×m selected cases may be divided into a set of n genes, each gene composed of m reference images (step 208). The number of initially selected cases is preferably based on the number of desired instances specified by the radiologist or doctor, and for which a default value may be provided. Each gene is preferably formed by concatenating the case numbers respectively corresponding to the m images of the gene (step 212). An example is shown in FIG. 3, which assumes, for simplicity of demonstration, a designated collection of merely 16 reference images numbered 0 to 15. With m set equal to 4, images numbered 9, 1, 11 and 3 are initially selected for gene 304 which is formed by concatenating the bits 308 corresponding to those images 9, 1, 11, 13. The concatenation, in effect, assembles four bit strings corresponding to the four image numbers 9, 1, 11, 13 into one composite bit string 308. In general, if there are N reference images in a collection, an image number is preferably configured with ceiling (LOG₂(N)) bits, where the ceiling function rounds up to the next largest integer. A collection of 1000 images is therefore indexed by image numbers having 10 bits each.

Referring back to FIG. 2, the Mahalanobis distance is determined for each of the n genes of the set just formed (steps 216, 220) in accordance with a genetic algorithm. As will be discussed in more detail further below, the genetic algorithm iteratively calculates the Mahalanobis distance, in accordance with an aspect of the invention, unless it has already been calculated for the gene. The Mahalanobis distance (or “metric”) is a measurement of the similarity between an unknown sample and a group of known samples, each sample having matching features whose values vary by sample. The metric is based in part on the in-group variances and covariances, which makes the Mahalanobis distance a more rigorous measure of one-to-many similarity. As applied in this invention, the Mahalanobis distance is calculated between the test image, i.e., that of the new tumor, and a group of reference images or gene. Preferably, the images of that group are all of the same known pathology, either malignant or benign. This allows the Mahalanobis metric to deliver a more meaningful assessment of similarity, i.e. similarity from which similar pathology can be inferred, between the group and the test image than one-to-one similarity techniques. Operationally, the Mahalanobis distance is calculated for genes that are iteratively altered by the genetic algorithm to arrive at a minimum distance and, therefore, a best gene. A standard formula for the Mahalanobis distance is:

D²_{G}(T)=(T−μ_{G})S_{G}⁻¹(T−μ_{G})′

where D is the Mahalanobis distance, T is a row matrix of feature values of the test image, S_{G} is the within-group covariance matrix, a μ_{G} is the row matrix of means of group feature values.

At the outset, the task of finding an optimal group of reference images based on Mahalanobis distance is not a straightforward problem, and a brute force approach of trying all possible combinations of the number of reference images requested is not feasible in terms of time and processing resources if the database contains a large number of known cases.

Genetic algorithms is a class of algorithms suited to solving problems for which a method of solving is unknown, but for which a proposed solution can be easily evaluated. A group of problem-solvers are recruited to each offer a respective solution to the problem. The solutions are assessed for merit, and the problem-solvers offering the best solutions are selected to pass on their genetic material to a next generation of problem-solvers so as to iteratively, over time, reach an acceptably good ultimate solution. Among the techniques utilized in genetic algorithms for passing on genetic material are random mutations and crossovers where, for example, the random fluctuations are confined to the top performing problem-solvers to, by chance, spawn even better problem-solvers. Low performers can be dropped as identified iteration to iteration. In this manner, a better and better solution evolves.

According to the invention, and referring again to FIG. 2, once the Mahalanobis distance is determined for each gene (steps 216, 220), it is determined whether a stopping criterion has been met (step 224). The stopping criterion may be a threshold such as a predetermined Mahalanobis distance or a processing time limit.

If the stopping threshold has not been met, one or more random crossovers and/or mutations may be applied to the gene(s) having the smallest Mahalanobis distance to the test image (step 228). With crossover and/or mutations, there are new genes generated and those with largest Mahalanobis distances are preferably discarded, and preferably to such an extent as to maintain a constant number of genes in the population.

Returning again to FIG. 3, one example of a mutation is performed on the zero bit 312 of gene 308, to change the bit to a 1 bit 316. In effect, a 1 bit is substituted for a 0 bit so that the image number 320 of 1 is transformed into the image number 324 of 5. Reference image 1, in other words, is replaced by reference image 5, preferably to create a new, additional gene 328 as an additional member of the set of genes being manipulated by the genetic algorithm. Mutations need not occur on every iteration of the algorithm, and are preferably are applied randomly to the bits of a gene. Importantly, any given mutation generally affects no more than one image of a gene, and very preferably less than all images of the gene since the genetic algorithm is based on passing on genetic material.

FIG. 4 demonstrates two examples of crossover. As shown in the first example, three of the bits of the gene 404 identifiable in FIG. 4 as darkened are transferred to the gene 408 in a swap that likewise transfers three of the bits of gene 408 identifiable as light to the gene 404. The swapping in the second example, for genes 412, 416, is performed for three bits that are not all consecutive. The swapping is preferably randomly applied to the bits and applied with greater frequency than that of mutations. The number of bits swapped, like other parameters of the algorithm, can be set to achieve a desired tradeoff of rigor in finding the greatest similarity and processing time/resources as empirically determined.

As has been demonstrated above, the present invention provides the user with automated diagnostic decision support that includes display of known tumor cases that are more similar, and more reliable as predictors of pathology, than that afforded by the known one-to-one similarity metrics.

While there have been shown and described what are considered to be preferred embodiments of the invention, it will, of course, be understood that various modifications and changes in form or detail could readily be made without departing from the spirit of the invention. For example, the user may override a classification result to cause the system 100 to search based on the opposite result, so that the physician can first see similar malignant cases and then similar benign cases, or vice versa. It is therefore intended that the invention be not limited to the exact forms described and illustrated, but should be constructed to cover all modifications that may fall within the scope of the appended claims.

1. An apparatus for comparing a test medical, multi-featured image of a tumor to a collection (204) of reference medical, multi-featured images of tumors determined to be malignant, or to a collection (204) of reference medical, multi-featured images of tumors determined to be non-malignant (112, 220), to identify ones of the reference images that are similar feature-wise to the test image, each of the features of the test and medical images having respective values, said apparatus comprising a processor (100) configured for designating one of the two collections, selecting reference images from the designated one to form respective groups of the selected images (208), applying a genetic algorithm to alter ones of the groups (228) and to determine which of the groups is at a minimum distance to the test image based on said values (216, 220).

2. The apparatus of claim 1, wherein said selecting forms a set of said groups and wherein said applying iteratively derives (228), from groups of the set, based on distances from the test image to respective ones of the groups of the set and until a stopping criterion is met (224), new groups of the set.

3. The apparatus of claim 2, said processor being configured to compute the distances as Mahalanobis distances (216).

4. The apparatus of claim 2, said apparatus being configured to perform the iterative deriving by calculating, based on said values and for each of the groups for which a Mahalanobis distance has not already been calculated (216, 220), a Mahalanobis distance between the test image and that group, determining if a stopping criterion has been met and if the criterion has not been met (224), substituting, in at least one of said groups, for at least one of said selected images a different image in the designated collection (228) and repeating said calculating to start another iteration (216, 220).

5. The apparatus of claim 4, said apparatus being configured for performing the steps of
assigning to each of said images in the designated collection a respective number (204);
selecting from among said numbers (208); and
assembling bit strings representative of the selected numbers to form a plurality of composite bit strings corresponding to respective ones of said groups (212, 304, 308).

6. The apparatus of claim 5, said processor being configured to change, in performing said substituting, at least one bit of at least one of the plural composite bit strings to form at least one additional composite bit string in a manner that does not change at least one bit string that served as a component in said assembling (312, 316).

7. The apparatus of claim 5, wherein the assembling concatenates representative bit strings in forming the composite bit strings (304, 308)

8. The apparatus of claim 5, wherein said substituting comprises selecting from among the composite bit strings and changing at least one bit of a selected one of the composite bit strings to form at least one additional composite bit string (228, 312, 316).

9. The apparatus of claim 5, wherein said substituting comprises the step of swapping bits between a pair of the composite bit strings (404, 408, 412, 416).

10. The apparatus of claim 5, wherein the substituting in said at least one of said groups comprises the step of choosing at least one of the reference images at random for said substituting (228).

11. The apparatus of claim 1, said processor being configured to compute the distances as Mahalanobis distances (216).

12. The apparatus of claim 1, comprising a random number generator for selecting at random in performing the selecting from among the reference images (208).

13. A method for comparing a test medical, multi-featured image of a tumor to a collection (204) of reference medical, multi-featured images of tumors determined to be malignant, or to a collection (204) of reference medical, multi-featured images of tumors determined to be non-malignant (112, 220), to identify ones of the reference images that are similar feature-wise to the test image, each of the features of the test and medical images having respective values, said method comprising the steps of:
a) designating one of the two collections (204);
b) selecting reference images from the designated one to form respective groups of the selected images (208); and
c) applying a genetic algorithm to alter ones of the groups and to determine which of the groups is at a minimum distance to the test image based on said values (216, 220, 224, 228).

14. The method of claim 13, wherein the distances are Mahalanobis distances (216).

15. The method of claim 13, wherein the step b) forms a set of said groups (212) and wherein the step c) iteratively derives (228), from groups of the set, based on distances from the test image to respective ones of the groups of the set and until a stopping criterion is met (224), new groups of the set.

16. The method of claim 13, further comprising the steps of:
assigning to each of said images in the designated collection a respective number (204);
selecting from among said numbers (208); and
assembling bit strings representative of the selected numbers to form a plurality of composite bit strings corresponding to respective ones of said groups (212, 304, 308).

17. The method of claim 13, wherein the step c) further comprises the steps of:
d) calculating, based on said values and for each of the groups for which a Mahalanobis distance has not already been calculated, a Mahalanobis distance between the test image and that group (216, 220);
e) determining if a stopping criterion has been met (224); and
f) if the criterion has not been met, substituting, in at least one of said groups, for at least one of said selected reference images a different reference image in the designated collection (228), and returning to step d) (216).

18. The method of claim 17, further comprising the steps of:
assigning to each of said images in the designated collection a respective number (204);
selecting from among said numbers (208); and
assembling bit strings representative of the selected numbers to form a plurality of composite bit strings corresponding to respective ones of said groups (212, 304, 308);
wherein said substituting in step f) comprises the step of changing at least one bit of at least one of the plural composite bit strings to form at least one additional composite bit string in a manner that does not change at least one bit string that served as a component in said assembling (312, 316).

19. A computer program product having a computer-readable medium that contains a computer program executable by a processor (100), said program for comparing a test medical, multi-featured image of a tumor to a collection (204) of reference medical, multi-featured images of tumors determined to be malignant, or to a collection (204) of reference medical, multi-featured images of tumors determined to be non-malignant (112, 220), to identify ones of the reference images that are similar feature-wise to the test image, each of the features of the test and medical images having respective values, said program comprising:
a) a sequence of instructions for designating one of two collections (204);
b) a sequence of instructions for selecting reference images from the designated one to form respective groups of the selected images (208); and
c) a sequence of instructions for applying a genetic algorithm to alter ones of the groups and to determine which of the groups is at a minimum distance to the test image based on said values (216, 220, 224, 228).
